(19) United States
(12) Patent Application Publication
(10) Pub. No.: US 2014/0096869 A1
(43) Pub. Date: Apr. 10, 2014

(54) A TREE PROCESSING DEVICE FASTENED TO A WORK MACHINE

(71) Applicant: Yrjo Raunisto, Hameenlinna (FI)

(72) Inventor: Yrjo Raunisto, Hameenlinna (FI)

(21) Appl. No.: 14/118,138

(22) PCT Filed: May 16, 2012
(86) PCT No.: PCT/FI2012/000025

§ 371 Date: Nov. 15, 2013

(30) Foreign Application Priority Data
May 16, 2011 (FI) 20110164
Jun. 29, 2011 (FI) 20110221

(51) Int. Cl. B27C 9/00

(52) U.S. Cl. CPC B27C 9/005
USPC 144/4.6

(57) ABSTRACT

Device processing wood (11) which stands freely or can be attached to a working machine which device comprises a body of the device wherein gripping elements are attached to the mentioned body of the device, such as pairs of clamps (2),(3) in order to grab, hold and move the wood (11), a sawing device (6) in order to cut the wood (11), a splitting device in order to split a cut block of wood and attachment devices (10, 14) for attaching the device to the working machine. The body of the device is a balk (13) which has the same direction as the wood to be processed and regarding the pairs of clamps (2);(3), which can be moved while resting on the mentioned balk, both pairs can be moved in the direction of the wood (11) to be processed.

The invention relates to a device which processes wood and stands freely or can be fastened to a working machine which device comprises a body of the device wherein gripping elements, such as pairs of clamps for grabbing, holding and moving the wood, a sawing device in order to cut the wood, a splitting device in order to split a cut block of wood and attachment devices in order to attach the device to the working machine are attached to the mentioned body of the device.

A device which processes wood into split billet according to the preamble above is previously known from a Finnish patent publication FI-118890 which discloses a working machine arrangement which comprises devices for felling the wood to be processed, devices for delimbing the wood and devices for cutting the body of the wood to a desired length. In addition to that the arrangement comprises devices for creating split billets which devices comprise elements for splitting the body of a cut wood in the longitudinal direction of the wood and comprise cutting elements for cutting the wood to a length corresponding to the length of the split billet.

In the above described working machine arrangement the felling of an upright tree requires the turning of the splitting blade away from the line of the wood, the making of split billet occurring after the felling requires the turning of the splitting blade again to the line of the wood. The action also requires that the body of the wood must be delimbed regarding the distance of the feeding before it is fed against the splitting blade with a pulse principle. The splitting of the wood requires force as well as delimbing, too, when one deals with big branches. Because of this enough force is required from the cylinder in both directions of motion which cylinder both pushes the wood against the splitting blade and in another direction pushes the delimbing blade for delimbing branches. Force is required especially in the splitting movement during which the cylinder is at its worst, in other words pulling in this described structure. For that reason the cylinder must be sized to have a fairly large diameter. The blade pattern of the splitting blade cannot be changed without changing the whole blade unit. If the diameter of the wood has a maximum size, the split billets will be big if the same blade pattern is used without taking the diameter of the wood into consideration.

When the working machine arrangement is built to perform many different functions and at the same time one aims to have a light structure, it leads to the fact that the body of the device realizing the arrangement will have branches in many directions including joints and protruding arms. These will be parts which make the structure weak.

With the device which can be attached to a working machine and processes wood according to the invention unexpected improvements can be achieved regarding the existing prior art and it is characteristic of the invention that the body of the device is a balk running along the direction of the wood to be processed and regarding the pairs of clamps which can be moved while resting on the mentioned balk both pairs can be moved in the direction of the wood to be processed.

The advantage of the invention is the fact that with the help of a simple, direct body balk a strong body can be created for the whole device in which case in order to create a reliable structure the devices and attachment elements needed for the invention are directly attached to this body balk. When the pairs of clamps grabbing the wood are both adjusted to be moveable, the wood can be pushed against the splitting blade with the help of both pairs of clamps, if needed in which case the splitting of the wood is ensured and cases, in which the wood gets stuck at the splitting blade, can be avoided.

Further the advantage of the invention is the fact that with the device the wood to be processed can be taken from the ground or pile, processing can be performed in such a way that the split billet drops at the platform of the transport vehicle, in a cage or a sack. As an alternative structure the device is attached to a base and can be used with electricity or machine power in which case in this version the wood can be fed between jaws which are open.

In the following the invention is described more detailed by referring to the accompanying drawings in which

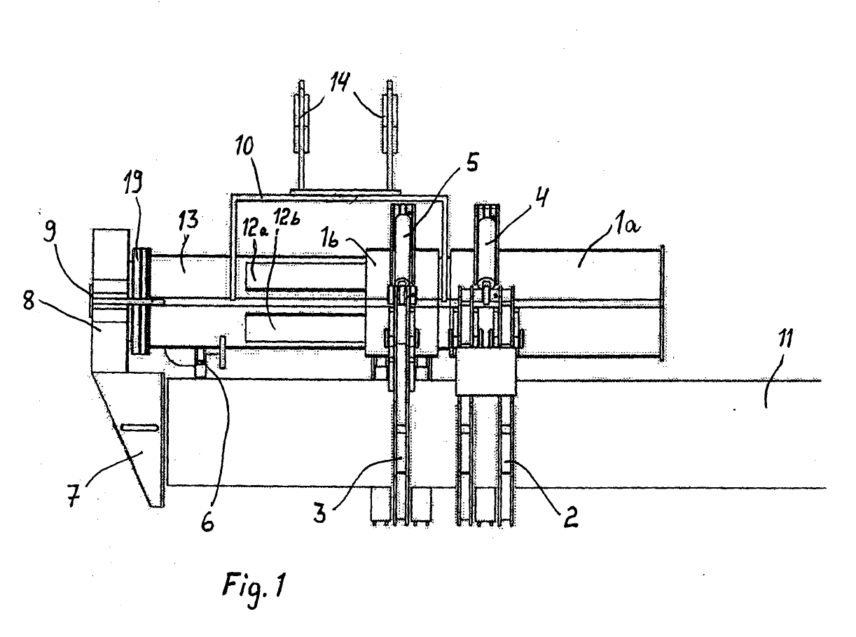

FIG. 1 shows a device according to the invention as a side view when the wood is placed in a starting position.

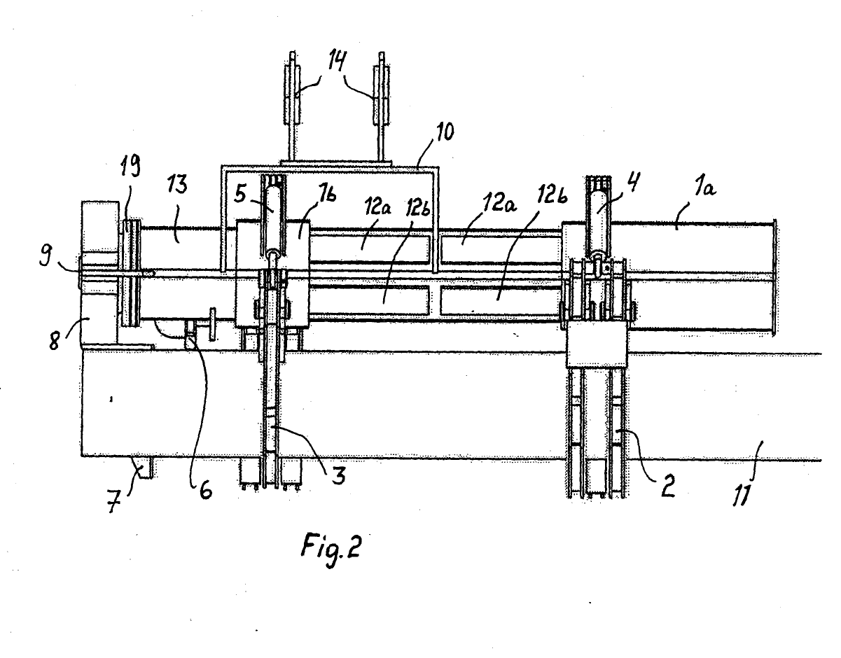

FIG. 2 shows a situation in which the first pair of jaws has pushed the wood with a pulsating motion and the second pair of jaws has returned to the starting position.

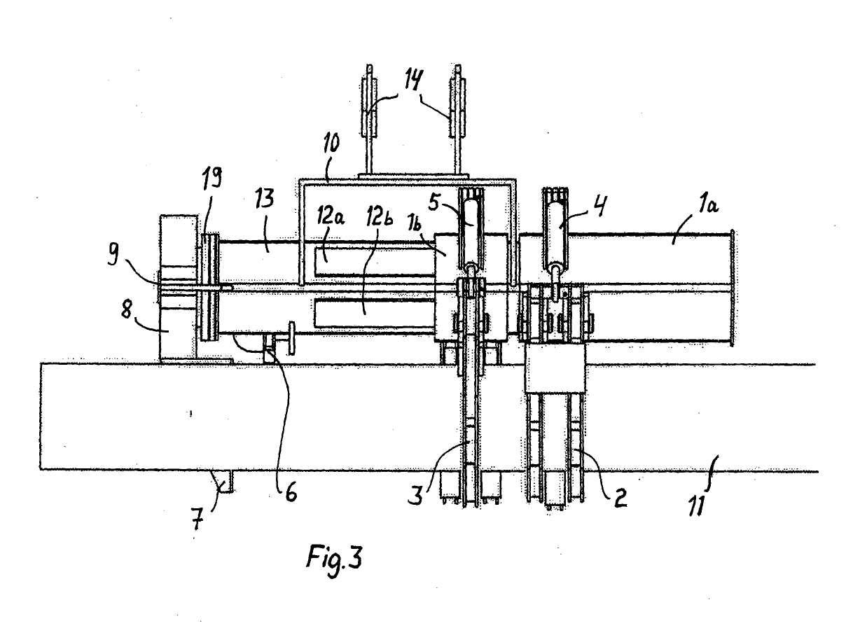

FIG. 3 shows a situation in which the first pair of jaws has been returned to the starting situation and the second pair of jaws has pushed the wood with a pulsating motion.

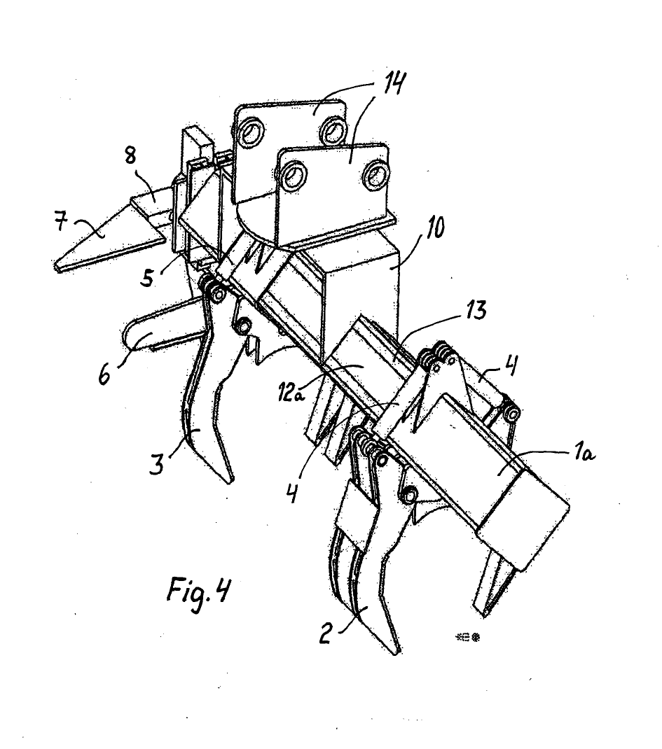

FIG. 4 shows the device diagonally as a side view.

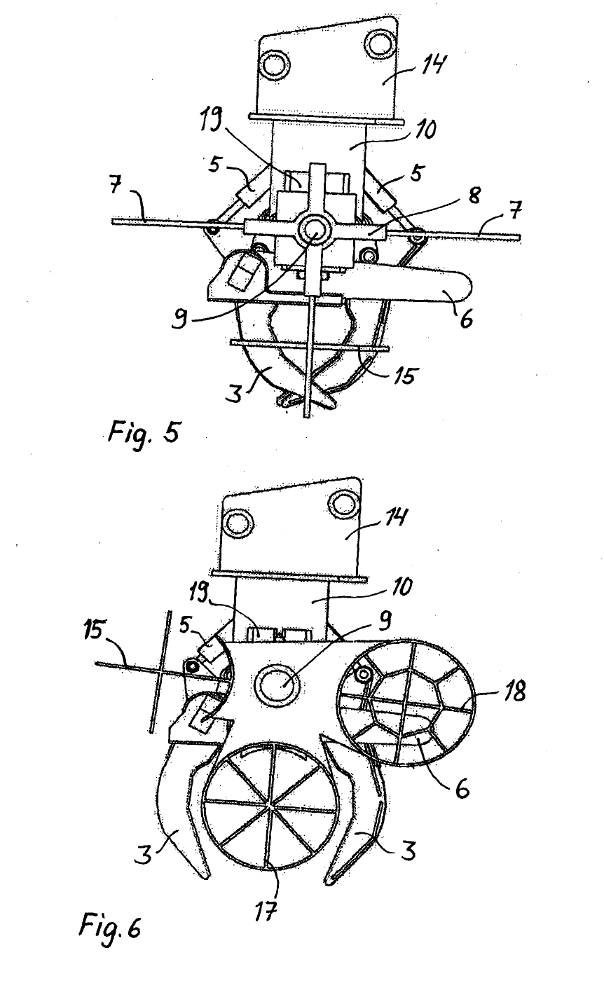

FIG. 5 shows a device seen from the end of the splitting device.

FIG. 6 shows a device seen from the end of the splitting device equipped with various blade units.

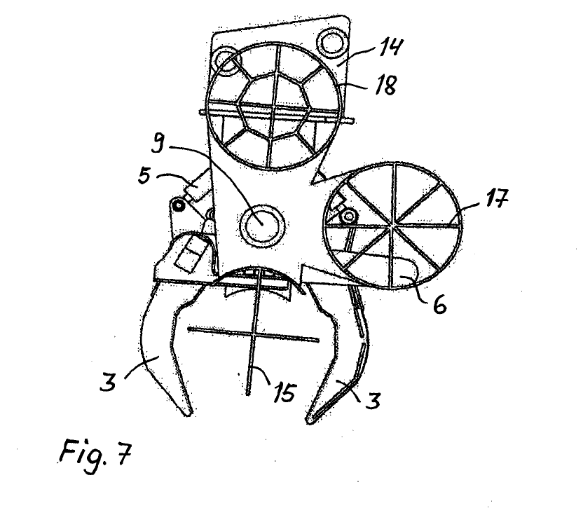

FIG. 7 shows a device seen from the end of the splitting device when the turret has been rotated.

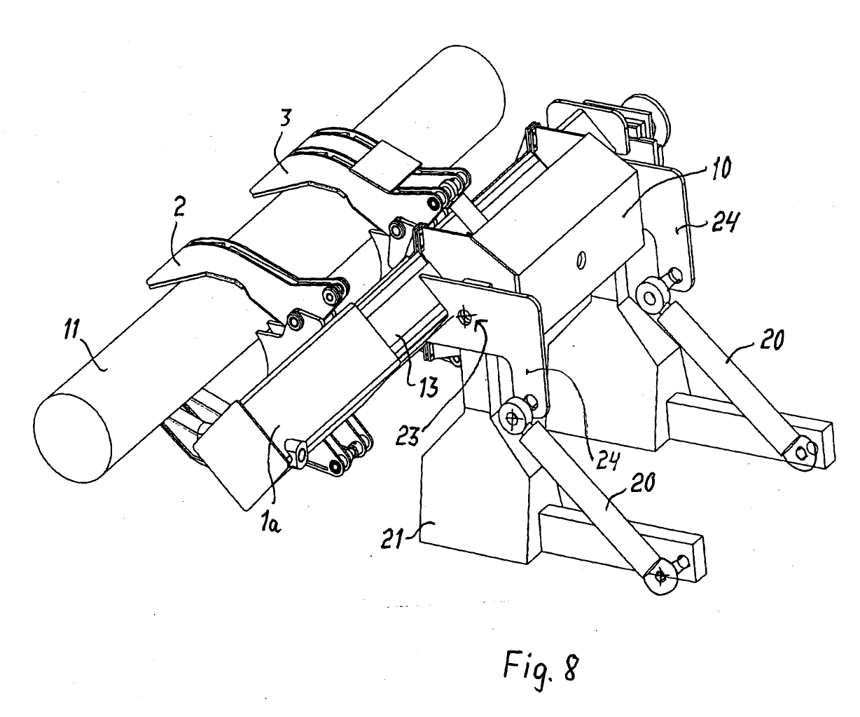

FIG. 8 shows a device which can be attached to be resting on a base or to a tractor diagonally seen.

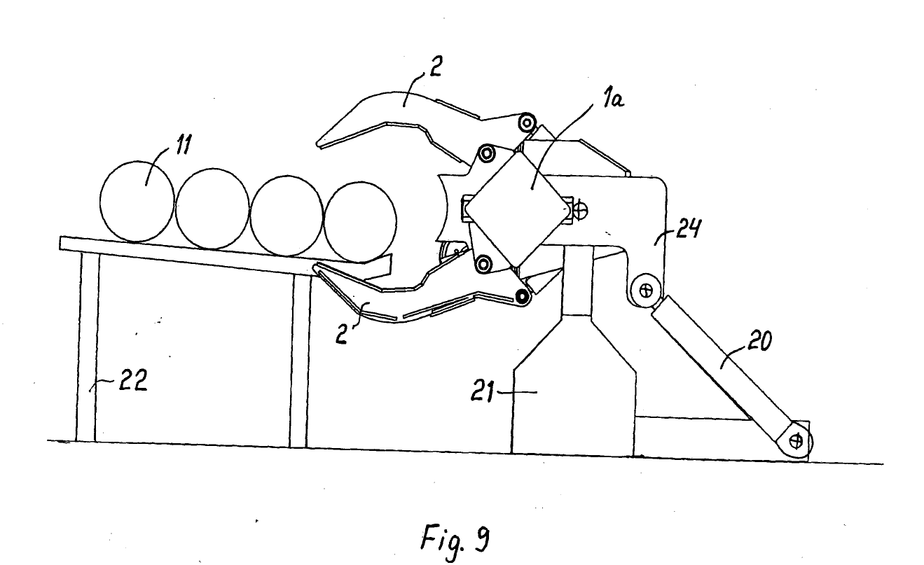

FIG. 9 shows the device of the FIG. 8 seen from the end.

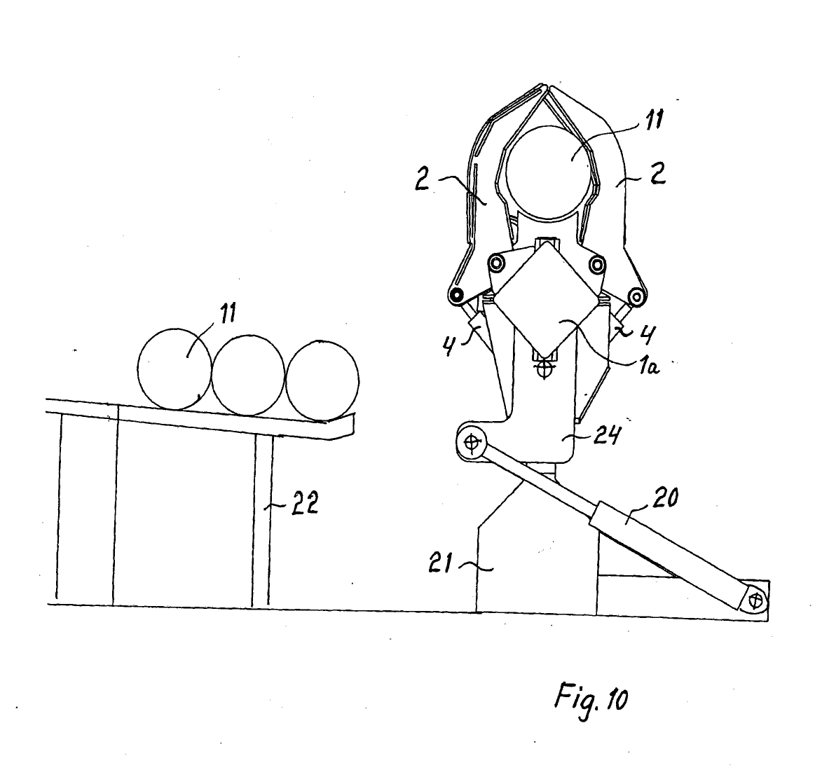

FIG. 10 shows the device of the FIG. 8 in a working position seen from the end.

In the FIG. 1 a split billet machine which can be attached to a working machine, such as to the end of a boom of an excavator, to a front loader or to the end of processing booms of timber is shown which split billet machine comprises a horizontal balk 13 as a body to which balk all the needed devices and attachments are adjusted. As an attachment device to the working machine an attachment body 10 and pin mounting arms 14 belonging to it are shown. The first pair 3 and second pair 2 of jaws are adjusted to be movable while resting on the balk 13. There are sliding elements 12a and 12b on the surface of the balk 13. The pair of jaws 3 is attached to a sleeve 1b sliding on the surface of the balk 13 and the pair of jaws 2 for its part is attached to a sleeve 1a sliding on the surface of the balk 13. The pairs of jaws 2, 3 are moved with the help of hydraulic cylinders (not shown). The cylinder moving the pair of jaws 2 and the sleeve 1a is advantageously inside the balk 13. The cylinder moving the pair of jaws 3 and the sleeve 1b is also most advantageously also inside the balk 13.

The cylinders 4 and 5 move the jaws of the pairs of jaws 2, 3 to be open and closed. There is a chain saw 6 at the lower edge of the balk 13 as a sawing device which chain saw cuts the wood 11 at the end of the pulsating motion performed by the pair of jaws 2 or 3 having the pushing turn when the movement of the wood 11 has stopped. There is a turret type splitting blade unit 8 next to the sawing device 6 attached to the end of the balk 13 in which splitting blade unit there is a blade 7 at the splitting line. A locking element 9 functions as the center and attachment element of the turret. Additionally there is a vertical guide bar 19 between the turret unit 8 and the end of the balk 13 by means of which guide bar the turret unit 8 can be moved a little bit in a vertical direction when the diameter of the wood varies. When the diameter of the wood 11 varies, a splitting blade which is suitable for the diameter size can be chosen at the turret unit 8 by rotating the unit 8 into a different rotating position.

In the FIG. 2 the moving of the wood 11 which has occurred in relation to the FIG. 1 with a pulsating motion to the left with the help of a pair of jaws 3 which has been moved while resting on the balk 13 is shown. The pair of jaws 3 has a grip on the wood 11. The pair of jaws 2 has no longer a grip on the wood. The wood has partly penetrated the splitting blade 7.

In the FIG. 3 the pair of jaws 3 has moved backwards with the jaws 3 open and simultaneously the pair of jaws 2 grabs the wood with the cylinder 4 and the pair of jaws 2 feeds the wood to the splitting blade 7 and is in the figure already at the end of the movement.

In the FIG. 4 the pairs of jaws 2 and 3 resting on the balk 11, their motion cylinders 3 and 4 and the joint and arm structures are shown more clearly. Regarding the placement of the parts of the pairs of jaws 2, 3 it is advantageous that the lower corner of the profile of the balk 13 is located lowest in which case the profile is a square located diagonally. The profile of the balk 13 can also have other form than a square regarding its cross section.

In the FIG. 5 a turret unit 8 is shown which turret unit has blades 7 and 15 as splitting blades. A sliding guide bar element 19 of the turret unit 8 allows the moving of the unit 8 in vertical direction with the help of an operational element, such as a hydraulic cylinder (not shown).

In the FIG. 6 there are splitting blades 15, 17 and 18 which are attached to the turret unit. With these the size of the split billet stays small although the diameter of the wood 11 would have a maximum size. In the FIG. 7 the unit is rotated into another position when the blade 15 is at the splitting line. Many different splitting blades can be adjusted to the turret head 8. FIGS. 5-7 show certain alternatives. The turret head can be implemented with even two different splitting blades.

The equipment according to the invention is controlled remotely at the cabin of a working machine. The pulsating motions of the pairs of jaws 2, 3 occur automatically controlled by an electrical control circuit belonging to the equipment. The length of the pulsating motion of the pair of jaws 3 defines the cut length of the block and thus the length of the split billet. If the first pair of jaws 3 cannot perform the splitting movement, the second pair of jaws 2 can be directed to push the wood 11 simultaneously against the splitting blade. Thus the splitting force can be doubled. This auxiliary function can occur automatically with the help of a control circuit or alternatively it may require a manual control.

In the invention the pairs of jaws 2, 3 are controlled with a pulsating motion in a normal situation so that when one pair of jaws pushes the wood 11 with the jaws being closed, the other pair of jaws makes a return movement backwards with the jaws open. When the pulsating motion has stopped the pairs of jaws alternate the above mentioned functions with each other. At the end of the pulsating motion the sawing device 6 performs the cutting of the wood. The feeding of the wood is efficient because the device is ready for a continuous pulsating motion. Only the cutting time of the sawing device defines the length of the pause occurring at the end of the pulsating motion. The feeding of the wood is considerably fast compared to the previous pulsating devices because in this case one does not have to wait at all the return movement of the jaw backwards because the other jaw is always ready to feed the wood.

In the FIG. 8 a device functioning while resting on a base 21 is shown the attachment body 10 of which device is adjusted to be turning while resting on a joint 23 attached to the base 21. The body balk 13, too, turns at the same time. The turning movement is realized with hydraulic cylinders 20 by means of connecting pieces 24. The turning movement is at least 90° in which case the jaws 2, 3 can be arranged to the side into a position receiving the wood when they are open. The jaws 2, 3 are turned up along the body balk 13 when the wood is being processed. The turning movement occurs around a shaft which has the same direction as the balk 13. The device can also be attached to a tractor and be lowered to the ground, if needed.

If the device is being used with electricity, the hydraulic unit with its control devices rotatable with an electric motor, can be located in the casing part of the base 21. The device control happens most advantageously with the help of a remote control. The device can also be controlled with hydraulics of a working machine or with rotational motion got from the working machine.

In the FIG. 9 the jaws 2, 3 are turned into a position in which the wood 11 can be received. The wood 11 is most advantageously located at a table 22 like base for grabbing performed by the jaws. In the FIG. 10 the jaws 2, 3 are turned up into the processing position of the wood 11.

In one embodiment the device equipped with a base is possible to detach from the base in which case it can be attached to the booms of an excavator or a front loader as a device according to the FIGS. 1-7 and thus it is a freely movable device during the usage.

1. Device processing wood (11) which stands freely or can be attached to a working machine which device comprises a body of the device wherein gripping elements are attached to the mentioned body of the device, such as pairs of clamps (2),(3) in order to grab, hold and move the wood (11), a sawing device (6) in order to cut the wood (11), a splitting device in order to split a cut block of wood and attachment devices (10, 14) for attaching the device to the working machine, characterized in that the body of the device is a balk (13) which has the same direction as the wood to be processed and regarding the pairs of clamps (2);(3), which can be moved while resting on the mentioned balk, both pairs can be moved in the direction of the wood (11) to be processed.

2. Device according to the claim 1, characterized in that regarding the pairs of jaws (2); (3) one is always adjusted to make a return movement with the jaws open when the other pair of jaws performs the feed motion of the wood (11) with the jaws being squeezed against the wood.

3. Device according to the claim 1, characterized in that the pairs of jaws (2);(3) can be adjusted to simultaneously push the wood (11) against the splitting blade.

4. Device according to the claim 1, characterized in that the second pair of jaws (2) is adjusted to push the wood (11) controlled by the control circuit of the device or manually against the splitting blade with the first pair of jaws (3) if the pushing movement of the first pair of jaws (3) stops.

5. Device according to the claim 1, characterized in that the balk (13) has the form of a square.

6. Device according to the claim 1, characterized in that the balk (13) is located in such a way that in the working position of the device the corner of the profile of the balk is located lowest.

7. Device according to the claim 1, characterized in that when the device comprises a base (21), the balk (13) and the devices attached to it which relate to the processing of the wood (11), such as pairs of clamps (2), (3) and the sawing device (6) are adjusted to turn along the balk (13) around the shaft which has the same direction as the balk (13).

8. Device according to the claim 1, characterized in that electricity and/or the hydraulics of a working machine or a rotational motion produced by the working machine is used as a moving force of the device.

9. Device according to the claim 1, characterized in that the device can be used while being attached to a working machine without a base (21) and with a base (21) used with electricity or used by a working machine.
